(19) United States
(12) Patent Application Publication
(10) Pub. No.: US 2018/0318678 A1
(43) Pub. Date: Nov. 8, 2018

(54) DEVICE FOR CARRYING GOLF CLUBS AND ACCESSORIES

(71) Applicants: Ivan TOMASI, Creazzo (IT); Antonio DELACHI, Kuala Lumpur (MY)

(72) Inventors: Ivan TOMASI, Creazzo (IT); Antonio DELACHI, Kuala Lumpur (MY)

(21) Appl. No.: 15/775,815

(22) PCT Filed: Nov. 11, 2016
(86) PCT No.: PCT/EP2016/077460

§ 371 Date: May 11, 2018

(30) Foreign Application Priority Data
Nov. 13, 2015 (IT) 102015000072301

(51) Int. Cl. A63B 55/60; B62B 3/02; B62B 3/12; B62B 5/06

(52) U.S. Cl. CPC A63B 55/60; B62B 3/02; B62B 3/12; A63B 55/50; A63B 2210/50; B62B 2202/404; B62B 2205/12; B62B 5/067

(57) ABSTRACT

A device for carrying golf clubs and accessories which includes a supporting trolley, associated in a lower region with at least one wheel assembly, and a bag for containing clubs. The device includes a component for quick coupling of the bag to the trolley, a release element which is associated with the quick coupling element and is adapted to allow the separation of the bag from the trolley.

### TECHNICAL FIELD

The present disclosure relates to a device for carrying golf clubs and accessories.

### BACKGROUND

Devices are known for carrying golf clubs and accessories which comprise a bag which defines a series of compartments that are adapted to accommodate the clubs and optionally pockets for containing accessories such as golf balls, items of clothing etc.

Typically, such bags can be associated with trolleys which have a resting base that is associated in a lower region with two or more wheel assemblies, and an upright.

The bag is rested on the resting base and kept locked to the upright by way of retaining straps associated with the upright and designed to be wound around the lateral surface of the bag.

In some cases the bags are integrated with the trolley.

The known solutions, although widely used, are not however devoid of drawbacks.

In particular, there is a certain inconvenience in the operations to couple and disengage the bag to and from the trolley.

### SUMMARY

The aim of the present disclosure is to solve the above mentioned problems, by providing a device for carrying golf clubs and accessories, the structure of which is extremely simplified with respect to the solutions known today.

Within this aim, the disclosure provides a device for carrying golf clubs and accessories that is easy to use and which offers the widest guarantees of reliability and safety in operation.

The present disclosure also provides a device for carrying golf clubs and accessories that can be obtained at low production cost.

This aim and these and other advantages which will become better apparent hereinafter are achieved by providing a device for carrying golf clubs and accessories comprising a supporting trolley, associated in a lower region with at least one wheel assembly, and a bag for containing golf clubs, the device comprises means for quick coupling of said bag to said trolley, and further comprising release means which are functionally associated with said quick coupling means and are adapted to allow the separation of said bag from said trolley and means for remote actuation of said release means, said remote actuation means being arranged proximate to a grip defined on said bag.

### BRIEF DESCRIPTION OF THE DRAWINGS

Further characteristics and advantages of the disclosure will become better apparent from the description of some preferred, but not exclusive, embodiments of the device for carrying golf clubs and accessories according to the disclosure, which are illustrated by way of non-limiting example with the assistance of the accompanying drawings wherein:

FIG. 1 is a perspective view of a first embodiment of the carrying trolley in the extended condition;

FIG. 2 is a view similar to the previous one of the carrying trolley in an intermediate condition between the extended condition and the folded condition;

FIG. 3 is a view similar to the previous one of the carrying trolley in the folded condition;

FIG. 4 is a perspective view of a variation of embodiment of the carrying trolley in the extended condition;

FIG. 5 is a perspective view of the carrying trolley of FIG. 4 in an intermediate condition between the extended condition and the folded condition;

FIG. 6 is a perspective view of the carrying trolley of FIG. 4 in the folded condition;

FIG. 7 is a perspective view of the device for carrying golf clubs and accessories;

FIGS. 8 to 10 show, in side views and in sequence, the steps of coupling a bag to the trolley shown in FIGS. 1 to 3;

FIGS. 11 to 13 show, in side views and in sequence, the steps of coupling a bag to the trolley shown in FIGS. 4 to 7;

FIG. 14 is a side view of the bag and of an actuation handle that can be associated with the bag;

FIG. 15 is an exploded view of the bottom of the bag;

FIG. 16 is a side view of the bag and of a portion of the trolley and of the quick coupling means;

FIG. 17 is an enlargement of the quick coupling means shown in FIG. 16, in the step of coupling;

FIG. 18 is a view similar to the one in FIG. 16 with the quick coupling means in the coupled condition;

FIG. 19 is a view similar to the previous one, in which the coupling means are released by the release means;

FIG. 20 is a partially exploded perspective view of a variation of embodiment of the device according to the disclosure;

FIG. 21 is a perspective view of a variation of the bag; and

FIGS. 22 and 23 are perspective views of two possible modes of use of the device according to the disclosure.

### DETAILED DESCRIPTION OF THE DRAWINGS

In the embodiments illustrated below, individual characteristics shown in relation to specific examples may in reality be interchanged with other, different characteristics, existing in other embodiments.

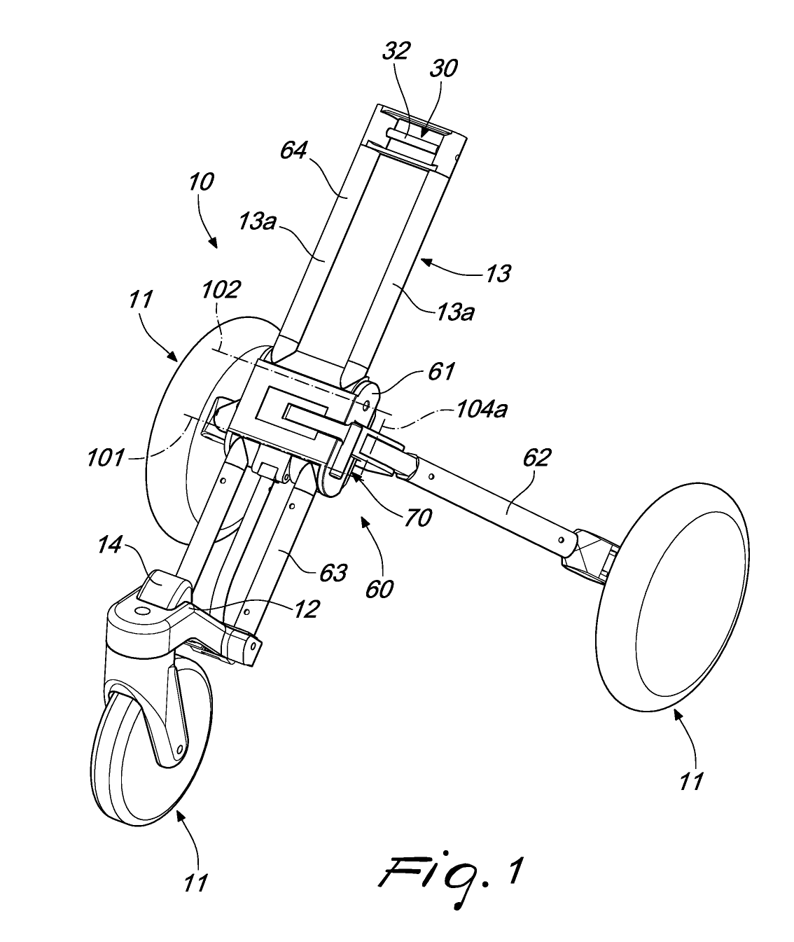

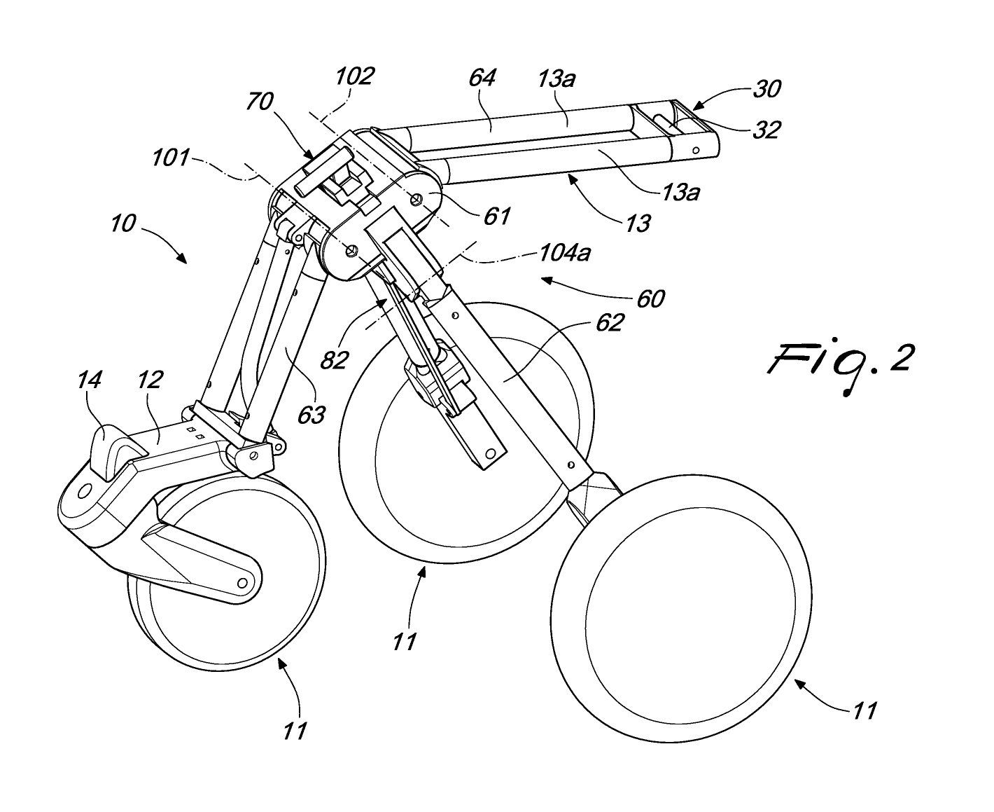

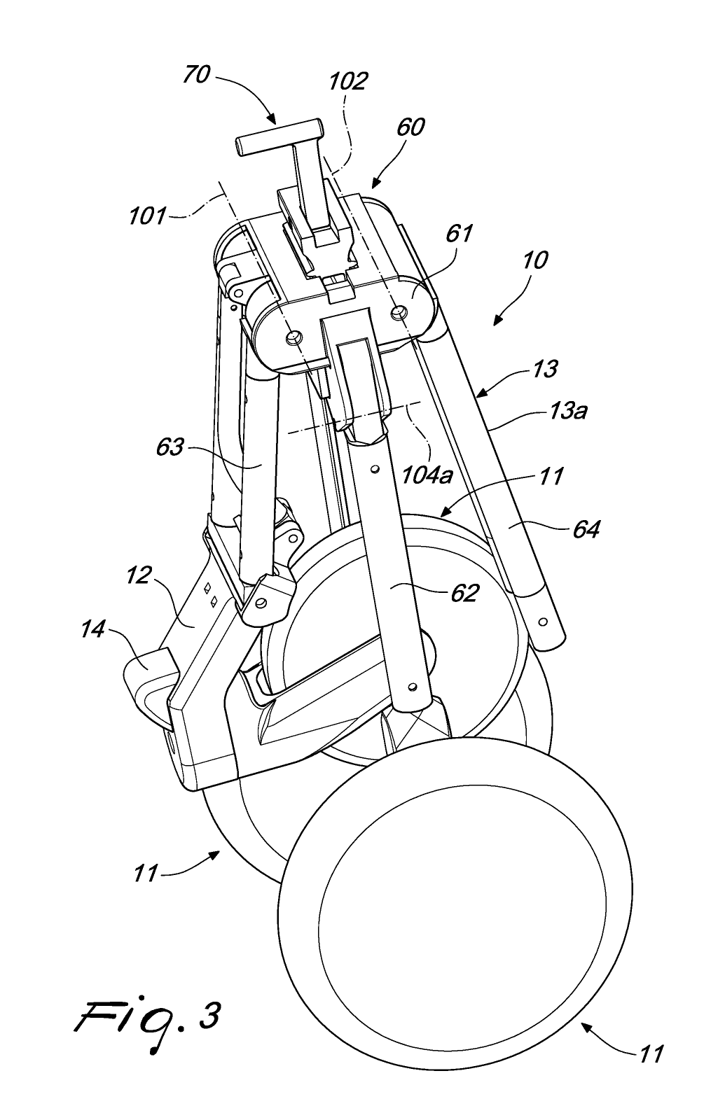

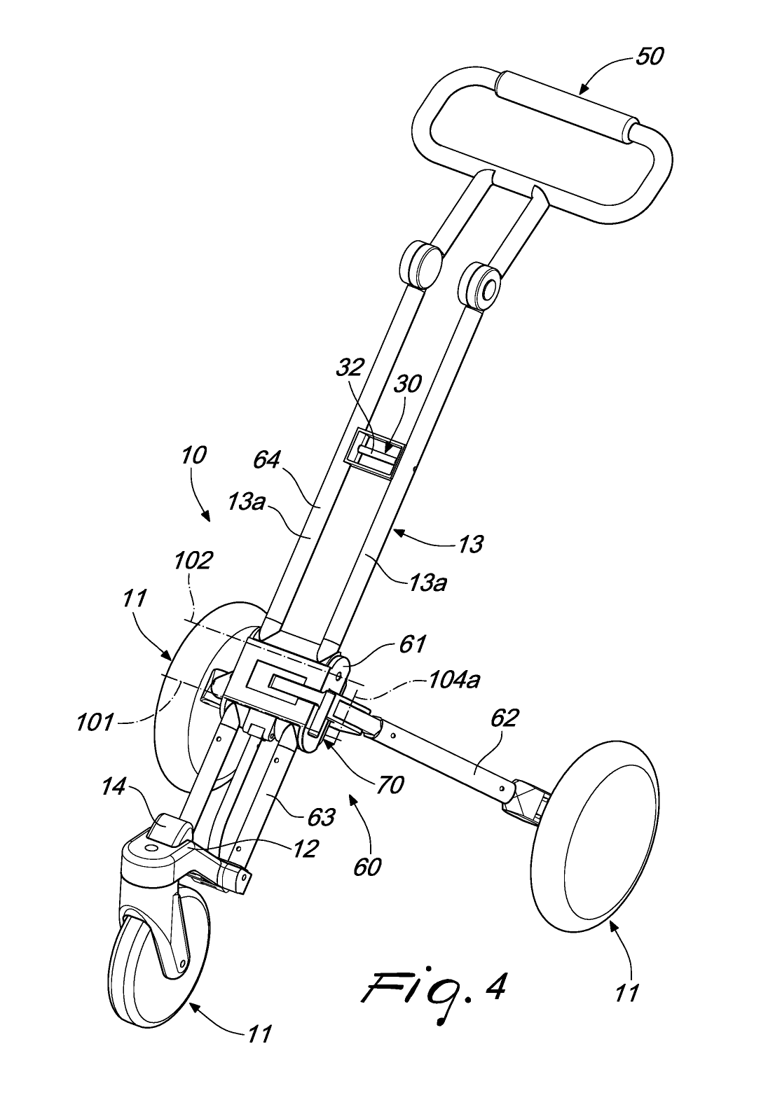

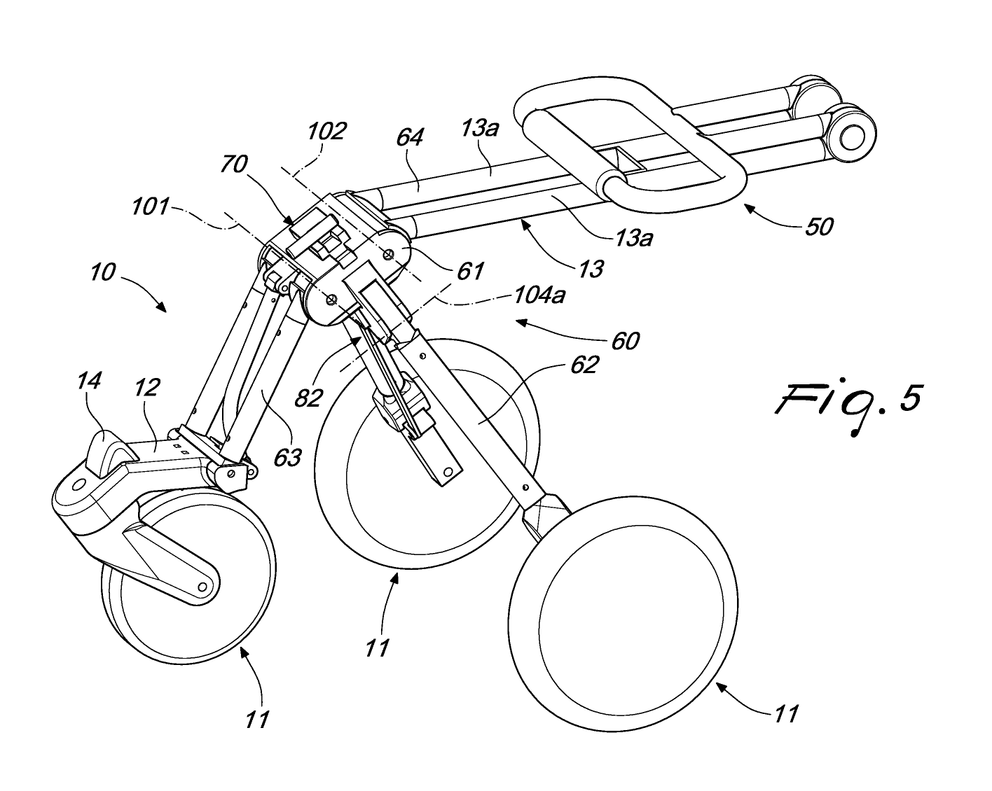

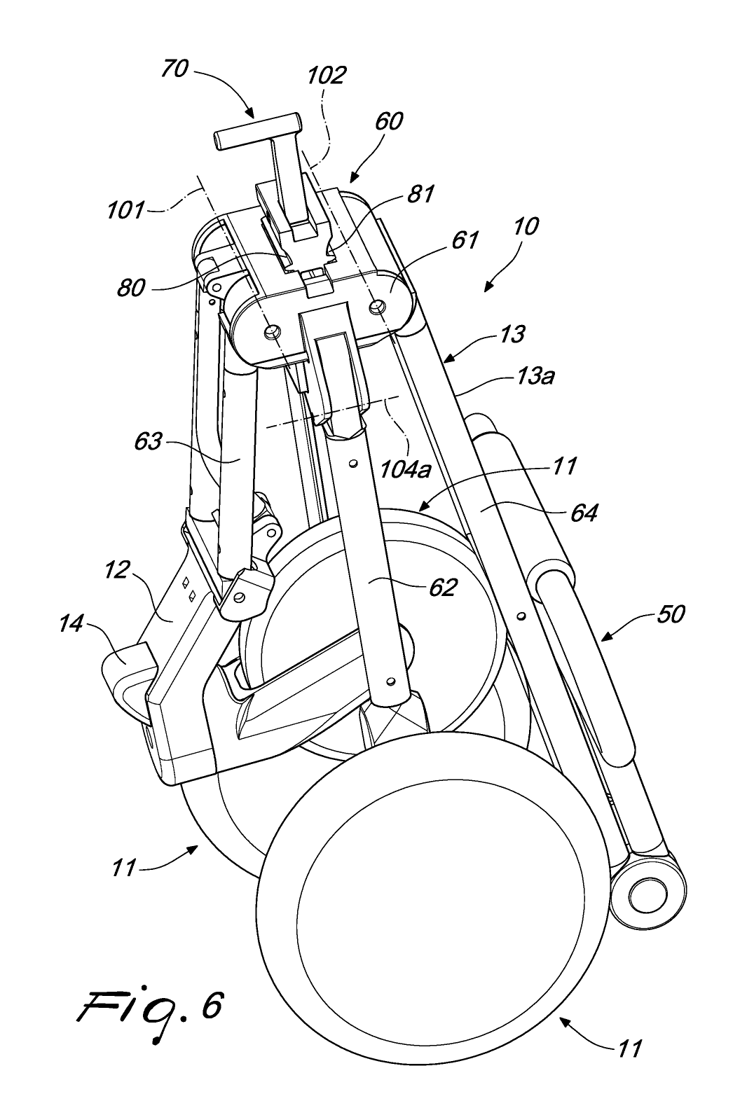

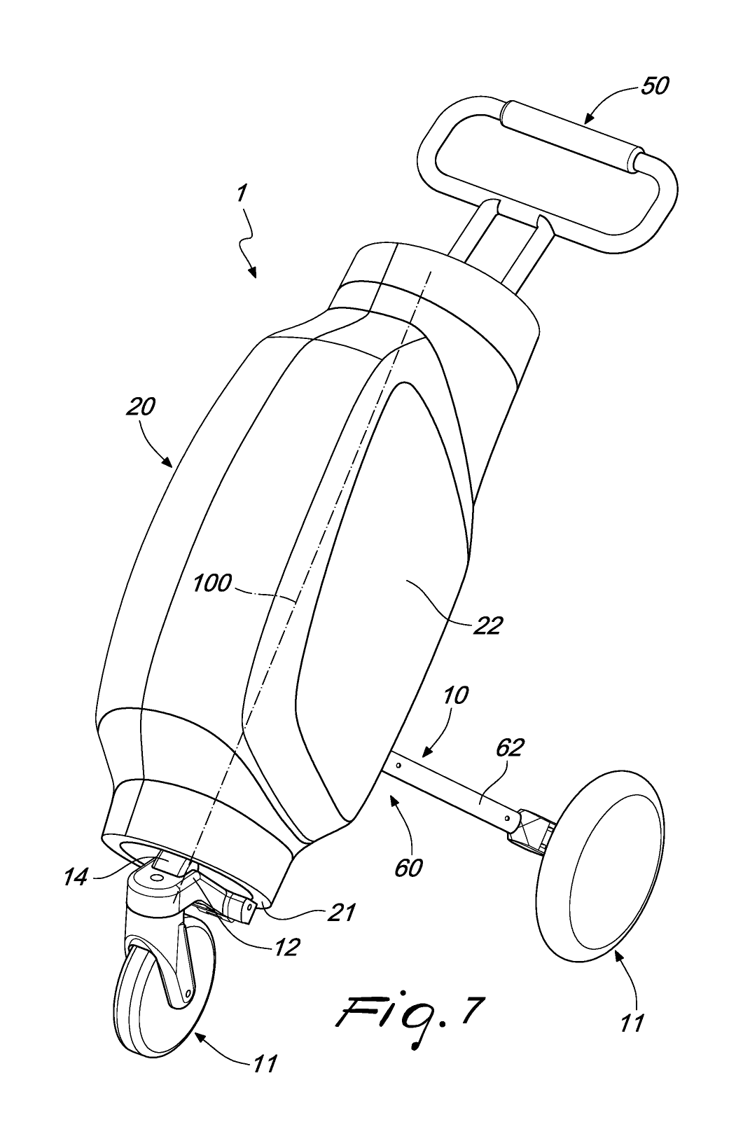

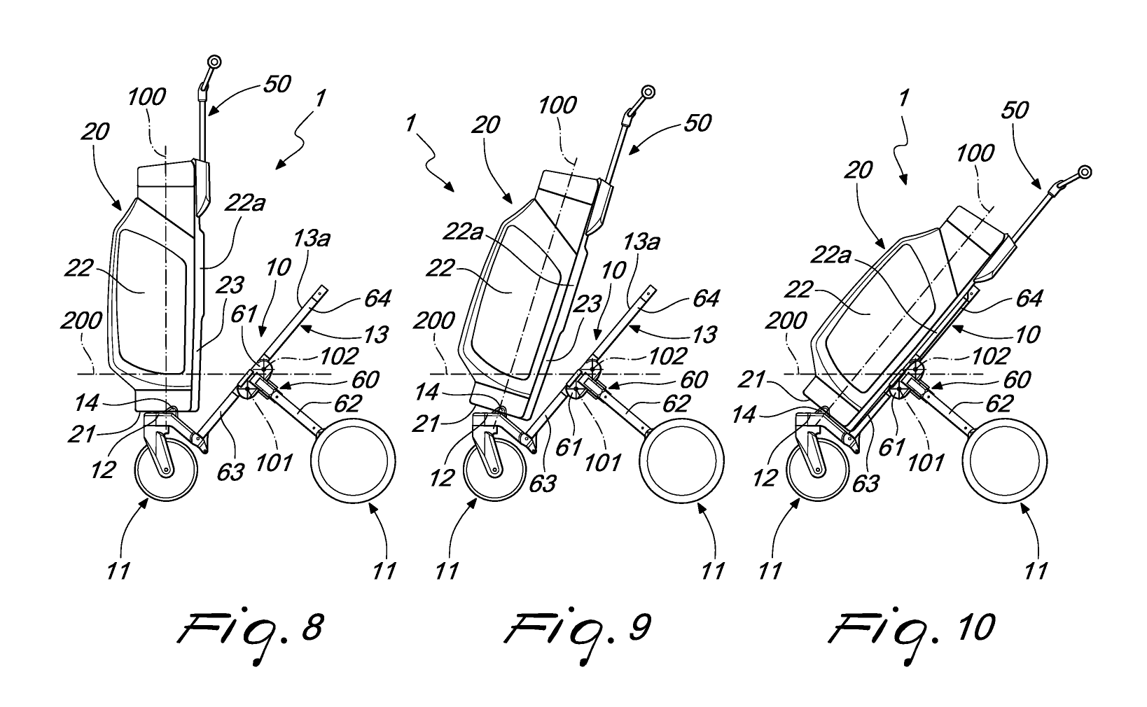

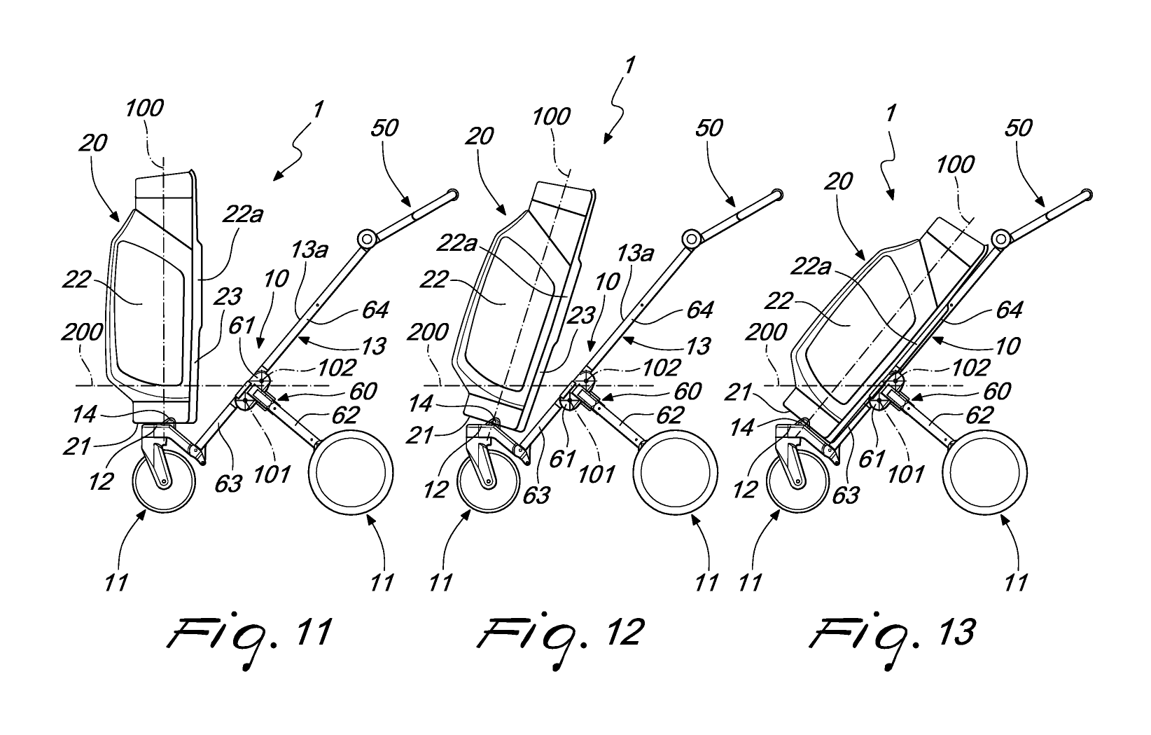

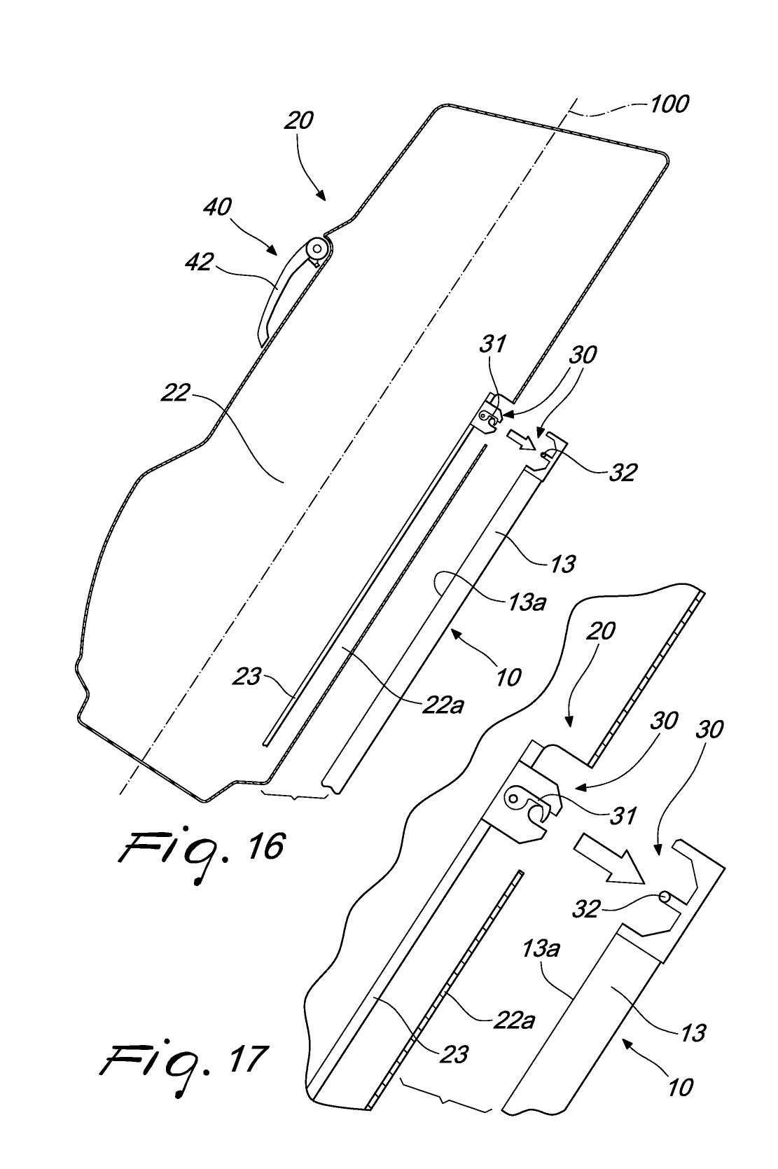

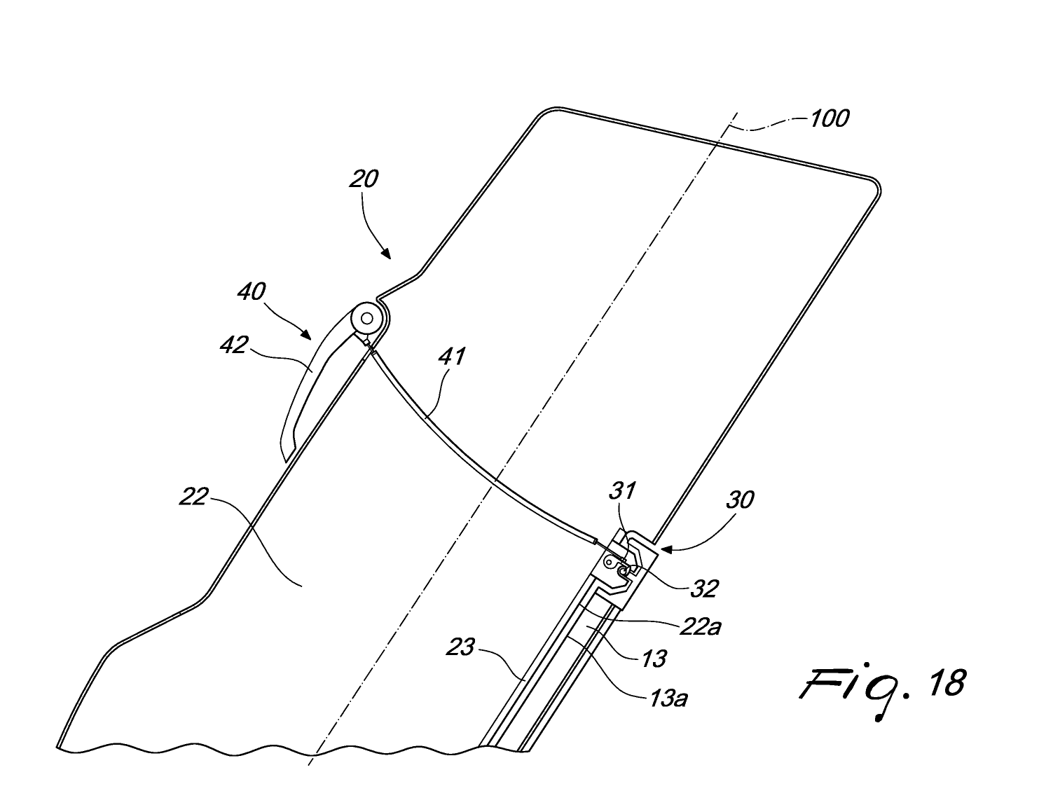

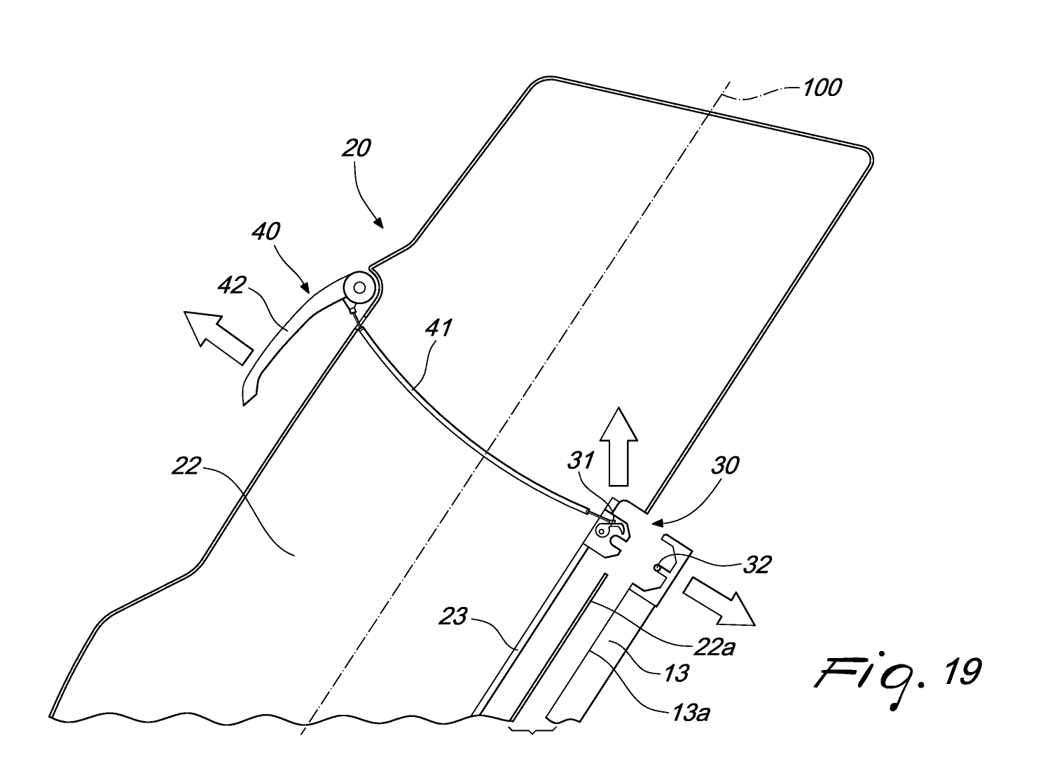

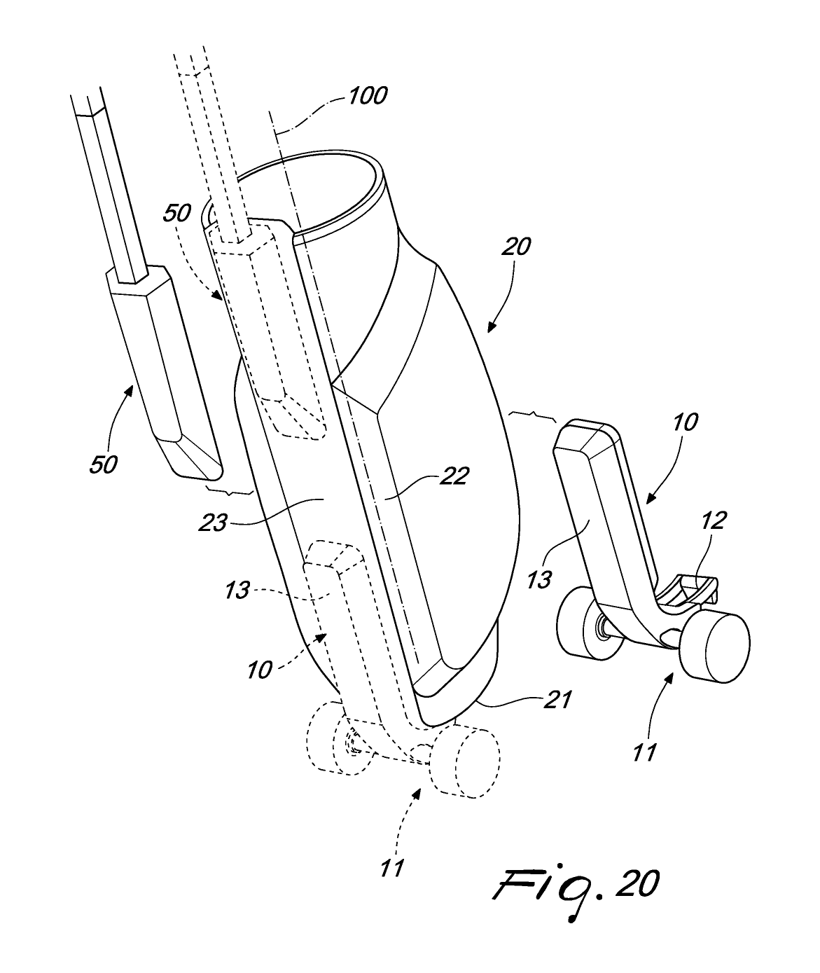

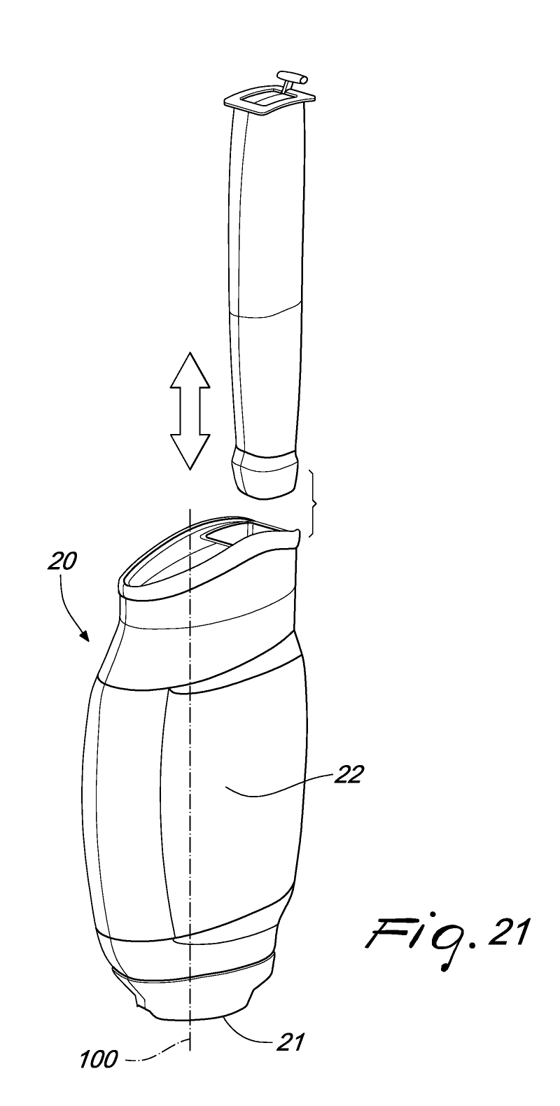

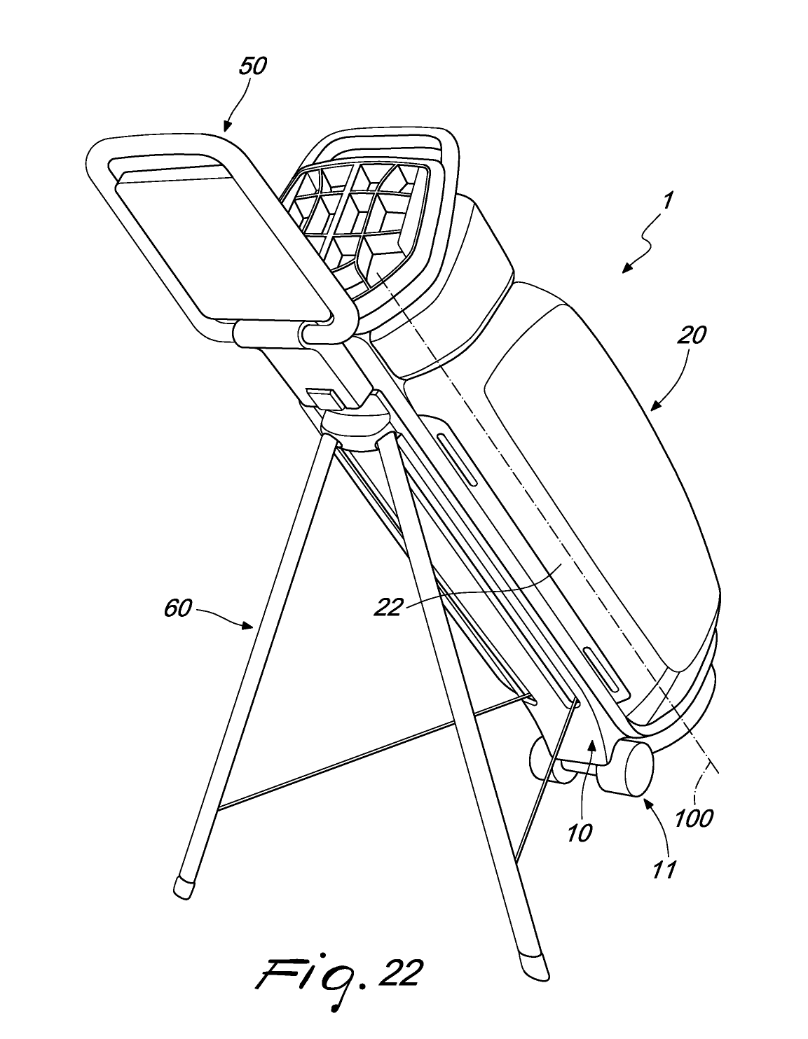

With reference to FIGS. 1-23, the present disclosure relates to a device, generally designated by the reference numeral 1, for carrying golf clubs and accessories.

The device 1 comprises a supporting trolley 10, which is associated in a lower region with at least one wheel assembly 11, and a bag 20 for containing golf clubs and optionally other accessories.

According to the present disclosure, the device 1 comprises means 30 for quick coupling of the bag 20 to the trolley 10.

Furthermore, release means 40 are provided, which are functionally associated with the quick coupling means 30, and are adapted to allow the separation of the bag 20 from the trolley 10.

According to a practical embodiment, the quick coupling means 30 comprise at least one first coupling element 31 which is associated with the bag 20, and at least one respective engagement element 32 which is associated with the trolley 10.

In particular, the first coupling element 31 is adapted to couple on the respective engagement element 32 by pressure.

Conveniently, the trolley 10 comprises a resting base 12 for at least one portion of the bottom 21 of the bag 20.

Furthermore, the trolley 10 comprises at least one upright 13, which is intended to define at least one abutment region 13a for a resting portion 22a defined at the lateral surface 22 of the bag 20.

The first coupling element 31 is defined at the resting portion 22a while the engagement element or elements 32 are defined at the abutment region 13a.

Advantageously, the bag 20 comprises at least one longitudinal stiffening member 23.

The longitudinal stiffening member or members 23 are associated or are associable with the lateral surface 22 of the bag 20 and, conveniently, at the back of the bag 20.

The longitudinal stiffening member or members 23 extend substantially parallel to the direction of longitudinal extension 100 of the bag 20.

Preferably, the engagement element 31 is supported by a longitudinal stiffening member 23.

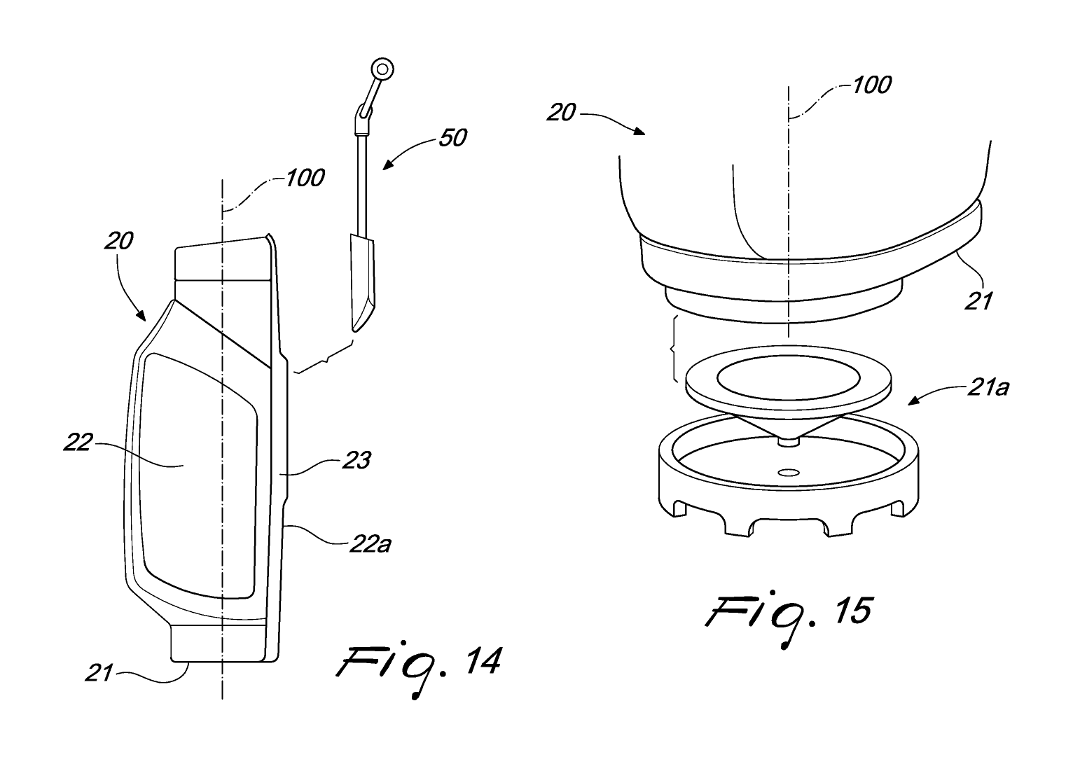

As shown in FIGS. 14 to 17, the device 1 comprises means 41 for remotely actuating the release means 40.

In particular, the remote actuation means 41 are arranged proximate to a grip 42 defined on the bag 20 so that the user can act on the release means 30 with the same hand used to lift the bag 20 using the grip 42.

The grip 42 can comprise a body that can be gripped, which can be for example flexible, soft or rigid, but also a shoulder strap for carrying the bag over a shoulder.

Preferably, the resting base 12 comprises at least one centering seat 14 which is designed to engage a respective centering element defined at the bottom of the bag 20.

In this manner, the operations to couple the bag 20 to the trolley 10 are extremely simple and intuitive.

Conveniently, as shown in FIGS. 14 and 20, the longitudinal stiffening member 23 comprises means for coupling to an actuation handle 50.

Likewise, the actuation handle 50 can be integrated in the longitudinal stiffening member 23.

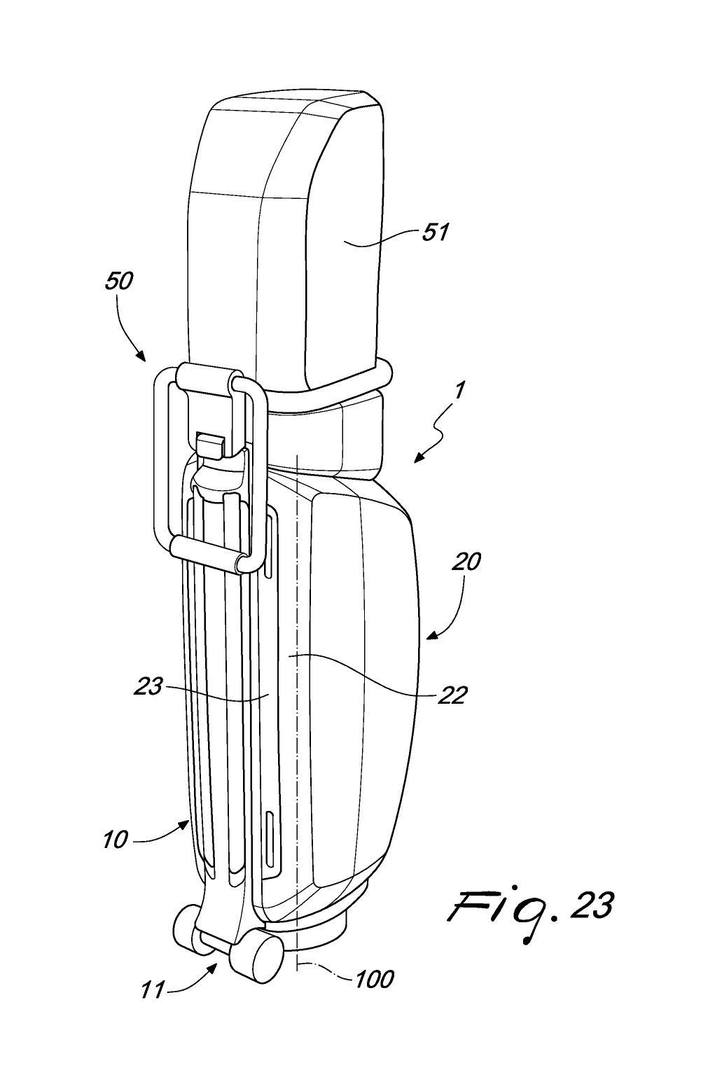

As shown in FIG. 23, the longitudinal stiffening member 23 can be advantageously used to support an upper protective “hood” 51 for transporting the device 1, for example on a train or on an airplane.

For the purposes of example, the longitudinal stiffening member 23 is associated with means for detachable engagement of the protective hood 51.

The actuation handle 50 can be associated detachably, in addition to with the trolley 10, with the longitudinal stiffening member 23 by virtue of for example coupling devices.

In this manner the device 1 is extremely flexible in its use, it being possible to selectively associate the bag 20 with different types of trolley 10 or with different types of actuation handle 50.

As shown in FIG. 22, the longitudinal stiffening member 23 can likewise be used to couple the bag 20 to supporting stands 60, for example for use on practice courses.

For this reason the longitudinal stiffening member 23 can be associated with a device that is adapted to couple the bag 20 to a supporting stand 60.

As shown in FIG. 15, it is possible for the bottom 21 of the bag 20 to be associated with a removable protective element 21a which is adapted to keep the bag 20 clean by preventing contact thereof with mud or water.

Aeration openings, optionally adjustable, can be provided at the bottom 21 of the bag 20, which are intended to ensure a good circulation of air in order to keep the inside of the bag 20 dry thus preventing the formation of mildew.

According to a further aspect, the disclosure relates to a device 1 wherein the trolley 10 comprises a folding chassis 60.

The chassis 60 comprises a base frame 61 which supports at least one first elongated element 62 and at least one second elongated element 63 which are connected in a lower region to corresponding wheel assemblies 11.

At least one between the first elongated element 62 and the second elongated element 63 can move, in rotation with respect to the base frame 61 about an articulation axis 101 that is substantially transverse to the direction of longitudinal extension 200 of the chassis 60 during its transition from an open, extended condition to a closed, collapsed condition and vice versa.

In particular, the base frame 61 further supports at least one sleeve tube 64 that can move in rotation with respect to the base frame 61 about a pivoting axis 102 that is substantially transverse to the direction of longitudinal extension 200 of the chassis 60 during its transition from the open, extended condition to the closed, collapsed condition and vice versa.

The chassis 60 comprises an actuation element 70 which is supported by the base frame 61 and can be actuated by the user in order to bring the chassis 60 from the open condition to the closed condition: the actuation element 70 can move with respect to the sleeve tube 64 and to the movable elongated element, and it is connected by way of first kinematic connection means 80 to the upright that can move with respect to the base frame 61 about an articulation axis 101 and, by way of second kinematic connection means 81, to the sleeve tube 64.

Actuation of the actuation element 70 produces the rotation, with respect to the base frame 61, of the upright that can move about the articulation axis 101 and of the sleeve tube 64 about the pivoting axis 102.

In the embodiment shown, the second elongated element 63 can move about the articulation axis 101.

The chassis 60 comprises, in particular, two first elongated elements 62.

The two first elongated elements 62 can move, with respect to the base frame 61, about a respective folding axis 104a, 104b which is substantially parallel to the central plane of the chassis 60 and substantially perpendicular to the direction of extension of the respective first elongated element 62.

Furthermore third kinematic connection means 82 are provided for connection between the actuation element 70 and the first elongated elements 62.

The third kinematic connection means 82 comprise articulation means that are adapted to produce, during the transition of the chassis 60 from the open, extended condition to the closed, collapsed condition, a mutual approach movement transversely of the two first elongated elements 62 by way of rotation about the respective folding axis 104a, 104b.

The articulation axis 101 and the pivoting axis 102 can be arranged mutually spaced apart; however, there is no reason why such axes cannot coincide.

It is possible to have the two first elongated elements 62 movable, with respect to the base frame 61, about a same folding axis 104a.

The articulation means comprise, for each first elongated element 62, an actuation link rod connecting the first elongated element 62 with the actuation element 70 and a guide link rod connecting each first elongated element 62 with the base frame 61.

The actuation link rods (which are moved by the actuation element 70) effectively produce the rotation of each first elongated element 62 about the respective folding axis 104a, 104b, while the guide link rods, which connect the base frame 61 with a support of the respective wheel assembly 11, correctly orientate the first elongated element 62 and the wheel assembly 11 in space and guide the folding thereof.

Advantageously, the second kinematic connection means 81 are different from the first kinematic connection means 80.

In practice, the first kinematic connection means 80 directly connect the actuation element 70 with the second elongated element 63 and the second kinematic connection means 81 directly connect the actuation element 70 with the sleeve tube 64.

In particular, the actuation of the actuation element 70 produces the rotation, with respect to the base frame 61, of the at least one elongated element that can move about the articulation axis 101 and of the sleeve tube 64 about the pivoting axis 102.

At the same time, the actuation element 70 actuates, by way of the third kinematic connection means 82, the folding of the first elongated elements 62 about the folding axis 104a, 104b.

Each wheel assembly 11 associated with the elongated element that can move about the articulation axis 101 can rotate, with respect to the respective elongated element, about a return axis that is transverse with respect to the direction of longitudinal extension 200 of the chassis 60.

Advantageously return means are provided which act between the base frame 61 and such wheel assembly 11 and are adapted to produce the rotation of the wheel assembly with respect to the respective elongated element 62 about the return axis 103 during the transition of the chassis 1 from the open, extended condition to the closed, collapsed condition and vice versa.

For the purposes of example, the return means comprise a return link rod having a first end rotatably connected to the base frame 61 and a second end rotatably connected to the wheel assembly 11 in farther position from the return axis.

According to a practical embodiment, the actuation element 70 can move, with respect to the base frame 61, along a movement path.

The movement path can be straight; however, there is no reason why such movement path cannot be curvilinear or shaped like a circular arc.

Preferably, the trolley 10 comprises an actuation element that is functionally associated with the actuation element 70.

By way of example, the actuation element comprises a lifting handle.

In this case, the action of the user on the lifting handle causes a first rotation of the handle about a rotatable connection area defined on the actuation element 70 and therefore, as a consequence of a lifting action, the movement along the movement path of the actuation element 70 and consequently the rotation, with respect to the base frame 61, of the elongated element that can move about the articulation axis 101 and of the sleeve tube 64 about the pivoting axis 102.

Conveniently, the actuation element 70 comprises a slider element that can move, with respect to the supporting frame 71, along a movement path and which defines a first and a second rack.

In this case, the first kinematic connection means 80 comprise a first portion of toothed gearwheel that meshes with the first rack and rotates integrally with the movable elongated element and extends about the articulation axis 101.

Similarly, the second kinematic connection means 81 comprise a second portion of toothed gearwheel that meshes with the second rack and rotates integrally with the sleeve tube 64 and extends about the pivoting axis 102.

The first kinematic connection means 80 can comprise a first link rod between the actuation element and the movable elongated element while the second kinematic connection means 81 can comprise a second link rod between the actuation element and the sleeve tube 64.

In this manner it is possible, by appropriately choosing the length of the first and of the second link rod and the pivoting points, to differentiate the angular movements of the movable elongated element and of the sleeve tube 64 respectively about the articulation axis and about the pivoting axis.

Obviously, there is no reason why a link rod cannot be used to provide the first kinematic connection means 80 and there is no reason why a rack-and-pinion coupling cannot be used to provide the second kinematic connection means 81 or vice versa.

Between the actuation element 70 and the base frame 61, holdback devices act to stop the movement of the actuation element 70 at the stroke limit position.

Preferably, the first kinematic connection means 80 and the second kinematic connection means 81 are constituted by rigid interconnection elements that are adapted to actuate the movement of the movable elongated element and of the sleeve tube 64 both during the transition from the extended condition to the collapsed condition and vice versa.

Use of a device 1 according to the disclosure is evident from the foregoing description.

In particular, the device 1, by virtue of the presence of the means for quick coupling the bag 20 to the trolley 10, and of the release means 40 which are functionally associated with the quick coupling means 30, makes it possible to couple and separate the bag 20 to or from the trolley, rapidly and in an extremely practical manner.

Implementation of the quick coupling means 30 using a first coupling element 31 associated with the bag 20 and a respective engagement element 32 associated with the trolley 10 enables coupling by pressure simply by placing the bag 20 on the trolley 10.

Furthermore, the optional presence of means 40 for remote actuation of the release means 33, arranged proximate to the grip 41 defined on the bag 20, makes it possible to uncouple the bag 20 from the trolley 10 in an extremely practical manner.

In practice it has been found that the chassis according to the disclosure fully achieves the set advantages.

All the characteristics of the disclosure, indicated above as advantageous, convenient or similar, may also be missing or be substituted by equivalent characteristics.

The individual characteristics set out in reference to general teachings or to specific embodiments may all be present in other embodiments or may substitute characteristics in such embodiments.

The disclosure, thus conceived, is susceptible of numerous modifications and variations, all of which are within the scope of the appended claims.

Moreover, all the details may be substituted by other, technically equivalent elements.

In practice the materials employed, provided they are compatible with the specific use, and the contingent dimensions and shapes, may be any according to requirements.

The disclosures in Italian Patent Application No. 102015000072301 (UB2015A005564) from which this application claims priority are incorporated herein by reference.

1-13. (canceled)

14. A device for carrying golf clubs and accessories, the device comprises a supporting trolley, associated in a lower region with at least one wheel assembly, and a bag for containing golf clubs, the device comprises means for quick coupling of said bag to said trolley, and further comprising release means which are functionally associated with said quick coupling means and are adapted to allow the separation of said bag from said trolley and means for remote actuation of said release means, said remote actuation means being arranged proximate to a grip defined on said bag.

15. The device according to claim 14, wherein said quick coupling means comprise at least one first coupling element associated with said bag and at least one respective engagement element associated with said trolley.

16. The device according to claim 15, wherein said at least one first coupling element is adapted to couple to the respective engagement element by pressure.

17. The device according to claim 14, wherein said supporting trolley comprises a resting base for at least one portion of a bottom of said bag and at least one upright configured to define at least one abutment region for a resting portion which is defined at a lateral surface of said bag, said at least one first coupling element being defined at said resting portion and said at least one engagement element being defined at said abutment region.

18. The device according to claim 14, wherein said bag comprises at least one longitudinal stiffening member which extends substantially parallel to a direction of longitudinal extension of said bag, said at least one engagement element being supported by said longitudinal stiffening member.

19. The device according to claim 17, wherein said resting base comprises at least one centering seat configured to engage a respective centering element defined at the bottom of said bag.

20. The device according to claim 18, wherein said longitudinal stiffening member comprises means for coupling to an actuation handle.

21. The device according to claim 18, wherein said longitudinal stiffening member is associated with means for detachable engagement of a protective hood.

22. The device according to claim 18, wherein said longitudinal stiffening member is associated with a device adapted to couple said bag to a supporting stand.

23. The device according to claim 17, wherein said bottom of said bag is associated with a removable protective element configured to keep said bag clean.

24. A device for carrying golf clubs and accessories, which comprises a supporting trolley, associated in a lower region with at least one wheel assembly, and a bag for containing clubs, the device comprises means for quick coupling of said bag to said trolley, said quick coupling means comprising at least one first coupling element which is associated with said bag and at least one respective engagement element which is associated with said trolley, and further comprising release means which are functionally associated with said quick coupling means and are adapted to allow the separation of said bag from said trolley, said trolley comprising a resting base for at least one portion of the bottom of said bag and at least one upright which is intended to define at least one abutment region for a resting portion which is defined at the lateral surface of said bag, said at least one first coupling element being defined at said resting portion and said at least one engagement element being defined at said abutment region, said bag comprising at least one longitudinal stiffening member which extends substantially parallel to the direction of longitudinal extension of said bag, said at least one engagement element being supported by said longitudinal stiffening member.

25. The device according to claim 24, wherein said resting base comprises at least one centering seat configured to engage a respective centering element defined at the bottom of said bag.

26. The device according to claim 24, wherein said longitudinal stiffening member comprises means for coupling to an actuation handle.
